(19) United States
(12) Patent Application Publication
(10) Pub. No.: US 2009/0265316 A1
(43) Pub. Date: Oct. 22, 2009

(54) System And Method For Facilitating Access To De-Identified Electronic Medical Records Data

(76) Inventors: John Poulin, Schenectady, NY (US); Emmanuel Tzavlakis, Cedar Grove, NJ (US); Mark Schiffer, New York, NY (US); Robert Pallay, Savannah, GA (US); Eric Pallay, Decatur, GA (US)

Correspondence Address: EDWARDS ANGELL PALMER & DODGE LLP, P.O. BOX 55874, BOSTON, MA, 02205, US

(21) Appl. No.: 12/106,639

(22) Filed: Apr. 21, 2008

(51) Int. Cl. G06F 7/06; G06F 17/30

(52) U.S. Cl. 707/3; 707/E17.014

(57) ABSTRACT

A system for providing access to data. The system comprises at least two data centers. Each data center including a processing computer effective to receive first data, the first data including patient identification data. The processing computer further effective to de-identify the first data to produce de-identified data. A database is in communication with the processing computer. The database is effective to receive and store the de-identified data. A central processor is in communication with the at least two data centers over a network, the central processor is effective to receive a query from a user computer, forward the query to the at least two data centers, receive responsive data from at least one of the data centers as a result of a search of the de-identified data, and forward the responsive data to the user computer.

### BACKGROUND OF THE INVENTION

### Field of the Invention

This disclosure relates to a system and method for managing and facilitating access to de-identified electronic medical records data.

The health care industry is rapidly changing and medical practitioners have begun to adopt electronic medical records (EMRs) to help in diagnoses and organization. EMRs aid in effective administration of care to patients as well as efficient management of medical business. The availability of EMRs provides benefits to patients, physicians and others doing business in the medical field. Medical practitioners in different practice settings, who use EMRs, could share clinically meaningful data to facilitate treatment and also gauge disease trends. Pharmaceutical representatives can determine the needs and trends of certain pharmaceutical products both locally and nationally. Companies who provide medical equipment are able to determine the needs of specific geographic areas to mold better business models.

Several systems have been employed to enable access to these EMRs. Some current systems permit doctors to contribute de-identified EMR data to a centralized accessible database. This database is accessible to others who may search the database for specific information.

### SUMMARY OF THE INVENTION

One embodiment of the invention is a system for providing access to data. The system comprises at least two data centers, each data center including a processing computer effective to receive first data, the first data including patient identification data, the processing computer further effective to de-identify the first data to produce de-identified data; the processing centers further include a database in communication with the processing computer, the database effective to receive and store the de-identified data. The system further includes a central processor in communication with the at least two data centers over a network, the central processor effective to receive a query from a user computer, forward the query to the at least two data centers, receive responsive data from at least one of the data centers as a result of a search of the de-identified data, and forward the responsive data to the user computer.

Another embodiment of the invention is a method for providing access to data. The method comprises at least two data centers, receiving first data, the first data including patient identification data; de-identifying the first data to produce de-identified data; and storing the de-identified data. The method further comprises at central processor: receiving a query from a user computer; forwarding the query over a network to the at least two data centers; receiving responsive data from at least one of the data centers as a result of a search of the de-identified data; and forwarding the responsive data to the user computer.

### BRIEF DESCRIPTION OF DRAWINGS

The drawings constitute a part of the specification and include exemplary embodiments of the present invention and illustrate various objects and features thereof.

FIG. 1 is a system diagram illustrating a system for managing and facilitating access to de-identified EMR data in accordance with an embodiment of the invention;

FIG. 2 is a system diagram illustrating a system for managing and facilitating access to de-identified EMR data in accordance with an embodiment of the invention; and

FIG. 3 is a flow diagram describing a method of managing and facilitating access to de-identified EMR data in accordance with an embodiment of the invention.

### DETAILED DESCRIPTION OF THE PREFERRED EMBODIMENT(S)

Various embodiments of the invention are described hereinafter with reference to the figures. Elements of like structures or function are represented with like reference numerals throughout the figures. The figures are only intended to facilitate the description of the invention or as a limitation on the scope of the invention. In addition, an aspect described in conjunction with a particular embodiment of the invention is not necessarily limited to that embodiment and can be practiced in conjunction with any other embodiments of the invention.

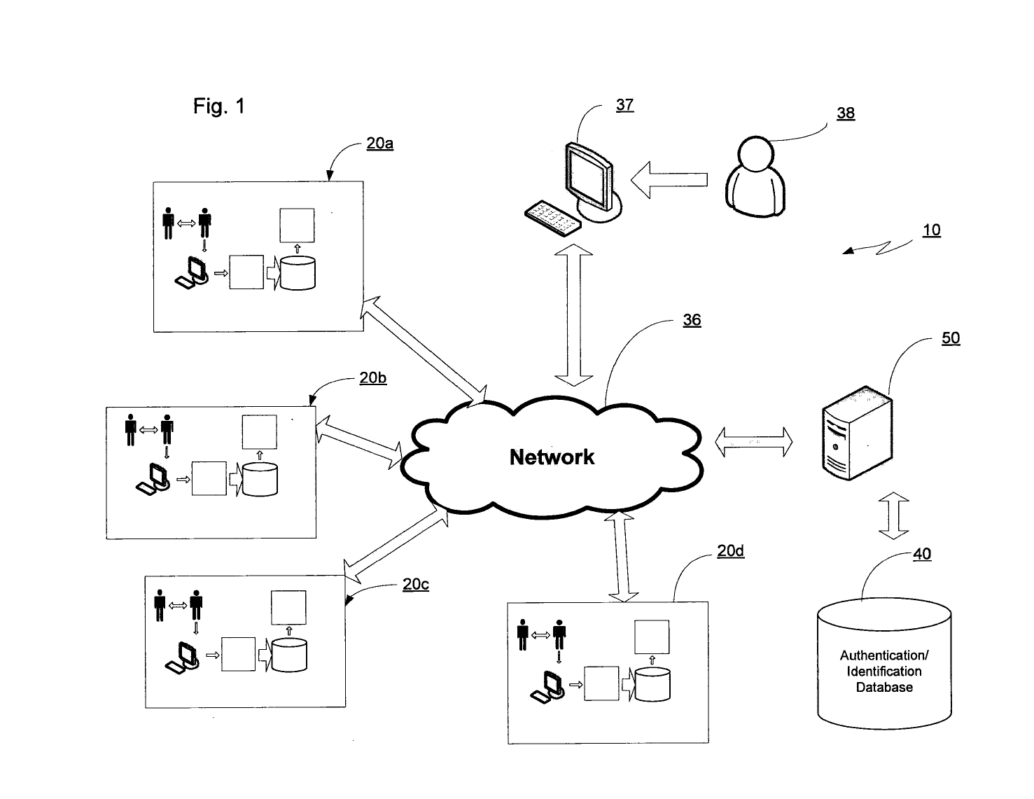

Referring now to FIG. 1, there is shown a system 10 for facilitating access to de-identified EMR data comprising a plurality of data centers 20a, 20b, 20c, and 20d, each data center effective to communicate data to a network 36. These data centers may be found at doctor's offices, clinics, hospitals, health insurance companies, disease management centers, or other locations which may contain aggregated and coded healthcare claims data.

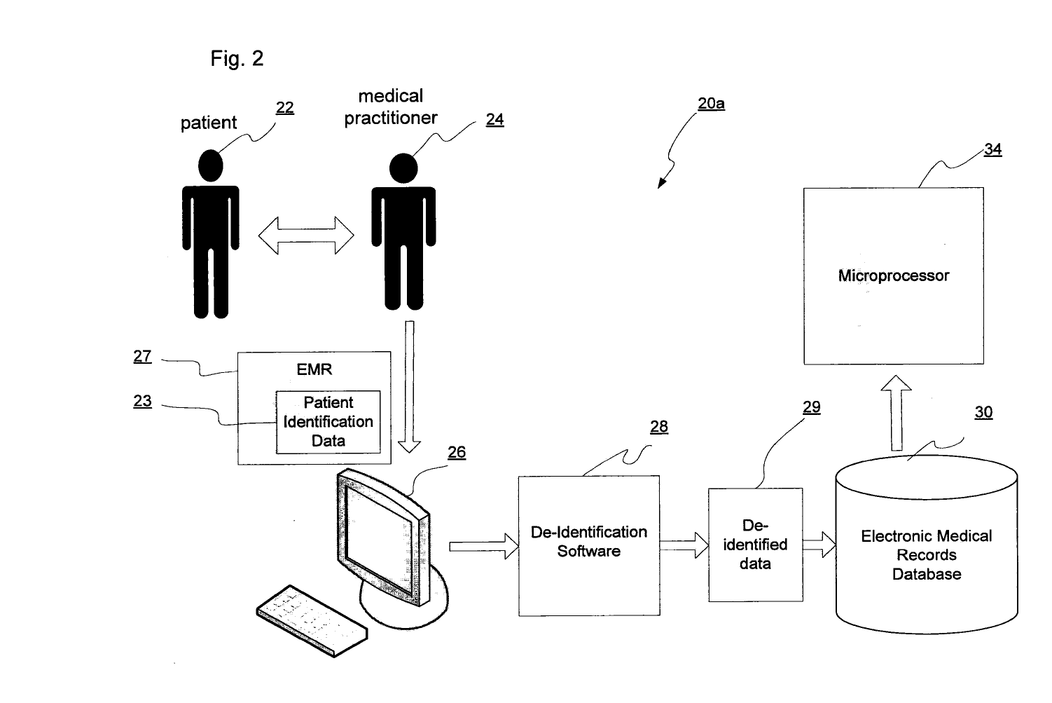

Referring momentarily to FIG. 2, at each localized data center 20, a patient 22 consults with a medical practitioner 24. At the consultation, medical practitioner 24 collects information from the patient including patient identification data 23 such as, name, address, telephone number and other information which may identify the patient. Medical practitioner 24 may further diagnose a patient, prescribe pharmaceuticals, recommend surgery or prescribe some other therapeutic care. Any part of this information, including any part of the patient identification data 23, are referred to herein, generally, as electronic medical records (“EMR”) data 27. EMR data 27 may be categorized by multiple attributes so as to facilitate searching such as: 1) location (country, region state, zip code, zone) 2) medical practitioner specialty (family practice, cardiology, etc.) 3) metric (immunization levels, breast cancer screening levels, cervical cancer screening levels, prostate cancer screening level, follow-up visit with medical practitioner following mental illness, hospitalization, etc.).

Medical practitioner 24 subsequently enters electronic medical records data 27 including patient identification data 23 into a processing computer 26. De-identification software 28 at processing computer 26 de-identifies the patient identification data 23 from the electronic medical records data 27 to produce de-identified data 29. When electronic medical records data 27 is de-identified, the patient identification data 23, including the name of the patient and any other information which links the electronic medical records data 27 to a specific person is redacted from the electronic medical record. De-identified data 29 is useful for diagnostic searches and, at the same time, can protect a patient's privacy.

The de-identified data 29 is stored in an electronic medical records database 30. De-identified data 29 is updated regularly in database 30. Such updates may be soon after the data is entered into processing computer 26. A microprocessor 34 coupled to database 30 is effective to access and transmit stored data in database 30 to central processor 50 through network 36 (FIG. 1).

Referring again to FIG. 1, each of the data centers 20 is in communication with central processor 50 through network 36. Network 36 may be wired, wireless, the Internet, an intranet, or any other network. A user 38 interested in searching data in system 10, can query system 10 by sending a query through a user computer 37 in communication with network 36 and central processor 50. For example, user 38 may request information regarding “diabetes.” The query is sent from user computer 37 to network 36 to central processor 50. Central processor 50 performs certain authentication by confirming that user 38 is entitled to access data in system 10 by, for example, comparing credentials of user 38 with credentials stored in a database 40. If user 38 is entitled to access to data in system 10, central processor 50 forwards the query to each of data centers 20a, 20b, 20c, and 20d for de-identified data relating to “diabetes.” Referring also to FIG. 2, at each data center, microprocessor 34 searches database 30 to retrieve responsive data and forward responsive data to central processor 50 and to user computer 37. If needed, user computer 37 may organize the responsive data. User 38 may submit an additional query if more information is required or to refine the parameters of the query.

User 38 may be a medical professional at a data center who wishes to access system 10 for diagnostic purposes. For example, a doctor may wish to access system 10 to retrieve data regarding treatment for a patient in a certain age or race demographic or with a specific ailment. The doctor can review what diagnostic tests he must run to be in compliance with accepted practices in the medical profession. For example, the medical professional may input an age, gender, and symptoms of depression and see whether physicians in his geographic area are prescribing ZOLOFT to their patients.

Alternatively, user 38 may run a query to obtain business information to compare his practice to the practices of other medical practitioners in the same field or in different fields. By collecting multiple points of information, system 10 is able to measure practice and physician performance and benchmark it against the aggregated pool of data. This aggregated pool can improve healthcare delivery and the health of the population.

User 38 may not be a medical professional and may wish to access network 36 mainly for business purposes. For example, user 38 may be a representative of a pharmaceutical company. The representative may run a query to determine the frequency of use of a particular pharmaceutical product in a specified geographical area. The representative can thereafter tailor his sales tactics using the data gathered from system 10.

As soon as a data center 20 with de-identified data 29 is capable of communicating with network 36, data center 20 becomes parts of system 10. A protocol may be used in conjunction with de-identification software 28 to facilitate such communication such as by sending medical record search requests over network 36, responding to search requests, aggregating responses, de-identifying physician identifiers, integrating with data sources, handling identity management, allowing for single sign on, etc.

Central processor 50 may be in communication with a database 40. Database 40 is effective to temporarily store (e.g., to facilitate performance optimization) information retrieved from data centers 20a, 20b, 20c and 20d. Database 40 may also store user authentication credentials used to selectively allow access to stored data in system 10, and identification hashes or keys for patients and medical practitioners so as to provide a unique ID for patients and medical practitioners in system 10. The patient identification could be generated using a hash of: first name, last name, date of birth, address, phone number, employee ID, health plan ID, and health insurance carrier. The physician identification could be generated using a hash of first name, last name, address, date of birth, phone number, UPIN (unique physician identification number), UPID (unique physician identification), DEA (drug enforcement administration) number, tax ID number, affiliations, specialties, and NPI (national provider identification) number.

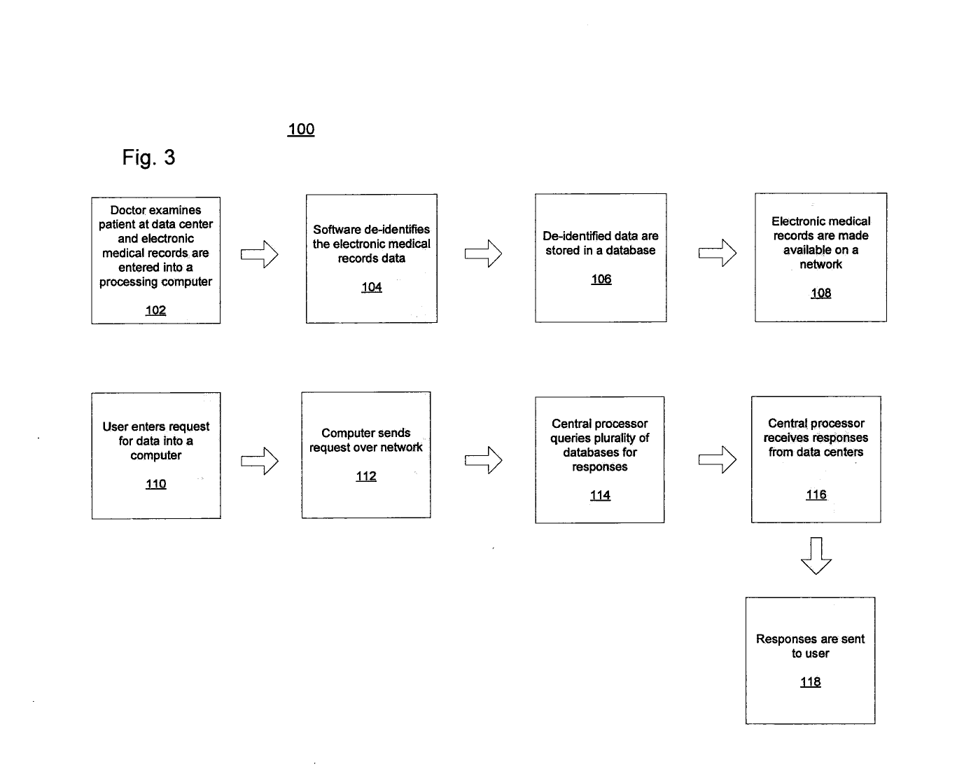

FIG. 3 illustrates a method of managing or facilitating access to de-identified electronic medical records. The process shown in FIG. 3 could be used with a system such as system 10 described with reference to FIG. 1. As shown in step 102, a medical practitioner examines a patient at a data center such as a doctor's office, hospital or any other location. The medical practitioner enters EMR data from the examination into a processing computer. The data may include information including the diagnosis, the type of pharmaceuticals prescribed, or any other relevant information. Referring to step 104, software de-identifies a patient's identification data from electronic medical records data. As shown in step 106, the de-identified data is stored in a database. In step 108, the de-identified data is made available to any other user on the same network with permission to access the de-identified data. A user may be required to pay a fee in order to access the de-identified data.

A process for querying the data will now be explained. Referring now to step 110, a user, who may be for example, a medical practitioner, a representative of a pharmaceutical company or business person, enters a request into a user computer for data. In step 112, the computer sends the request over the network. In step 114, a central processor receives the request and sends a query to multiple data centers in communication with the central processor for responses to the user's request. In step 116, the central processor receives responsive data. The responsive data may be organized into a user friendly format such as a report. As shown in step 118, the responsive data are sent back over the network to the user computer. The process can be repeated for different sets of de-identified data. Alternatively, a request incorporating multiple sets of de-identified data may be made.

Referring again to FIG. 1, various methods may be used to monetize system 10. For example, a medical practitioner 24, such as doctors, nurses, hospital administrators or the like, or a remote user 38, who may be a representative of a pharmaceutical company, a representative of a medical device company, or any individual, may be charged a fee to access data in system 10. The fee may be a one time transactional fee which bills the user per search or a subscription fee which bills the user prior to a given period of use. When the user is a medical practitioner who supplies data into system 10, the fee charged may be less than for remote user 38 or any user that does not contribute data to system 10.

Each user 38 can be licensed to access certain types or quantities of data. For example, users may be given: unlimited access for a period of time (e.g. 6 months); a limited quantity of data that may be downloaded (e.g. 100 MB of information or data relating to 1 million patients); open ended metered user where a license fee is resolved periodically. Usage may be segmented by location, medical practitioner specialty or metric.

System 10 enables analytics on de-identified data not available in the prior art. For example, central processor 50 can overlay responsive identified data onto geographic maps for analysis based on location. The map may illustrate the use of a certain pharmaceutical in a given region. These geographical maps can help a medical practitioner make decisions regarding diagnoses or alternatively, the information may help a user more effectively determine the scope of his or her business in a particular region.

System 10 also may also provide quality reporting and disease management information. Central processor 50 may be effective to communicate with other pieces of software to enable data sharing with other applications that utilize electronic medical records data.

System 10 can be expanded almost instantaneously. Whenever a new medical practitioner 24 adds appropriate software to his or her processing computer 26 and connects to the central processor 50, the processing computer 26 is almost immediately added to system 10. De-identified electronic data can be added from the new processing computer, which increases the amount of data in system 10 and adds new de-identified electronic data 29 to the system.

The system described herein provides advantages over systems currently in use. In prior art systems, electronic medical records data are not searchable until they arrive at a national database. Data on these systems may not be current. It may take a user a day, a week, a month or longer before updating his information to the database making the data old and less relevant to users who wish to access the data. For example, if the data is aggregated weekly, the data that can be acquired is, at best, a week old. Such data is not useful in life threatening situations. The current system removes the inherent latency in updating a system by providing access to electronic medical records data almost as soon as they are inputted into the processing computer.

The invention has been described with reference to an embodiment that illustrates the principles of the invention and is not meant to limit the scope of the invention. Modifications and alterations may occur to others upon reading and understanding the preceding detailed description. It is intended that the scope of the invention be construed as including all modifications and alterations that may occur to others upon reading and understanding the preceding detailed description insofar as they come within the scope of the following claims or equivalents thereof. Various changes may be made without departing from the spirit and scope of the invention.

What is claimed is:

1. A system for providing access to data, the system comprising:
at least two data centers, each data center including:
a processing computer effective to receive first data, the first data including patient identification data, the processing computer further effective to de-identify the first data to produce de-identified data; and
a database in communication with the processing computer, the database effective to receive and store the de-identified data;
a central processor in communication with the at least two data centers over a network, the central processor effective to:
receive a query from a user computer;
forward the query to the at least two data centers;
receive responsive data from at least one of the data centers as a result of a search of the de-identified data; and
forward the responsive data to the user computer.

2. The system as recited in claim 1, wherein a data center processor at each data center receives the query and searches the respective database in communication with the respective processing computer to produce at least some of the responsive data.

3. The system as recited in claim 1, wherein the at least two data centers are at least one of a doctor's office, a hospital, a clinic, a health insurance company and a disease management center.

4. The system as recited in claim 1, further comprising a central database coupled to the central processor, the central processor effective to receive identification data from the user, compare the identification data with data stored in the central database, and forward the query to the at least two data centers in response to the comparing.

5. The system as recited in claim 1, wherein the central computer forwards the responsive data based on a user license.

6. The system as recited in claim 1, wherein the responsive data includes de-identified data overlaid on geographic data.

7. The system as recited in claim 1, wherein the responsive data relates to pharmaceutical products in a geographic area.

8. The system as recited in claim 1, wherein the first data is EMR data.

9. The system as recited in claim 1, wherein the user computer is not one of the data centers.

10. The system as recited in claim 9, wherein the user computer is charged a fee greater than if the user computer were one of the data centers.

11. A method for providing access to data, the method comprising:
at, at least two data centers:
receiving first data, the first data including patient identification data;
de-identifying the first data to produce de-identified data; and
storing the de-identified data;
at, a central processor:
receiving a query from a user computer;
forwarding the query over a network to the at least two data centers;
receiving responsive data from at least one of the data centers as a result of a search of the de-identified data; and
forwarding the responsive data to the user computer.

12. The method as recited in claim 11, further comprising:
at, the at least two data centers, searching the respective databases in communication with the respective processing computers to produce at least some of the responsive data.

13. The method as recited in claim 11, wherein the at least two data centers are at least one of a doctor's office, a hospital, a clinic, a health insurance company and a disease management center.

14. The method as recited in claim 11, further comprising a central database coupled to the central processor and further comprising, at the central processor:
receiving identification data from the user;
comparing the identification data with data stored in the central database; and
forwarding the query to at least two data centers in response to the comparing.

15. The method as recited in claim 11, wherein the responsive data relates to pharmaceutical products in a geographic area.

16. The method as recited in claim 11, wherein the forwarding responsive data is based on a user license.

17. The method as recited in claim 11, wherein the responsive data includes de-identified data overlaid on geographic data.

18. The method as recited in claim 11, wherein the first data is EMR data.

19. The method as recited in claim 11, wherein the user computer is not one of the data centers.

20. The method as recited in claim 19, wherein the user computer is charged a fee greater than if the user computer were one of the data centers.
